(19) United States
(12) Patent Application Publication
(10) Pub. No.: US 2026/0222422 A1
(43) Pub. Date: Jul. 30, 2026

(54) DOMAIN NAME PREFILTERING FOR MALICIOUS WEBSITE DETECTION VIA PASSIVE DOMAIN NAME SYSTEM (DNS) RECORDS

(71) Applicant: Palo Alto Networks, Inc., Santa Clara, CA (US)

(72) Inventors: William Russell Melicher, Sunnyvale, CA (US); Oleksii Starov, Sunnyvale, CA (US)

(21) Appl. No.: 19/040,969

(22) Filed: Jan. 30, 2025

(51) Int. Cl. H04L 9/40

(52) U.S. Cl. CPC H04L 63/1416; H04L 63/1441

(57) ABSTRACT

A lightweight domain name classifier leverages efficiently computable features from passive Domain Name System (DNS) records to prefilter benign-classified domain names prior to those domain names being crawled for malicious website detection. The lightweight domain name classifier is an ensemble comprising multiple models that each receive respective sets of values for the efficiently computable features as inputs, and one or more dense layers of the lightweight domain name classifier combine outputs of the models and output malicious scores. Using the lightweight domain name classifier to prefilter domain names prior to crawling those domain names reduces computing resources allocated to crawling by an order of magnitude.

### BACKGROUND

The disclosure generally relates to data processing (e.g., CPC subclass G06F) and to computing arrangements based on specific computational models (e.g., CPC subclass G06N).

Passive Domain Name System (DNS) records record metadata associated with the action of resolving domain names, e.g., by observing and recording DNS resolutions for Internet traffic across an organization and storing the records in a centralized database. “Passive” refers to recording DNS records of observed traffic as opposed to “active”, which refers to actively querying DNS servers to observe and record up-to-date DNS resolutions. Types of DNS records include A records which record a mapping between a domain name and an Internet Protocol (IP) version 4 address, AAAA records which record a mapping between a domain name and an IP version 6 address, CNAME records which record a mapping between a domain name and another domain name, etc. Passive DNS records also include fully qualified domain names (FQDNs). Passive DNS records are used for cybersecurity techniques such as malware detection, for instance by tracking IP addresses mapped to known malicious domain names over time.

### BRIEF DESCRIPTION OF THE DRAWINGS

Embodiments of the disclosure may be better understood by referencing the accompanying drawings.

FIG. 1 is a schematic diagram of an example system for training a lightweight domain name classifier to prefilter domain names prior to crawling using weak signals for malicious domain name detection from passive DNS records.

FIG. 2 is a schematic diagram of an example system for deploying a trained lightweight domain name classifier to prefilter domain names prior to crawling the domain names for malicious website detection.

FIG. 3 is a flowchart of example operations for training a lightweight classifier for prefiltering of domain names using partially weak signals for malicious domain detection.

FIG. 4 is a flowchart of example operations for deploying a trained lightweight classifier for prefiltering domain names prior to crawling for malicious website detection.

FIG. 5 depicts an example computer system with a passive DNS record database, a lightweight domain name classifier, a feature preprocessor, and a classifier trainer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Passive DNS records include data for massive amounts of DNS resolutions. Even within a single organization or across a small number of organizations, the number of FQDNs recorded in passive DNS records can number in the millions or billions daily. As a result, the computational resources and bandwidth for crawling and classifying domain names to obtain more accurate malicious or benign classifications becomes beyond available and/or reasonable amounts of resources/bandwidth.

The present disclosure proposes leveraging partially weak signals for malicious domain name from passive DNS records to enable prefiltering of likely benign domain names prior to crawling those domain names. The partially weak signals manifest as lightweight features computed directly from passive DNS records. Periodically, a feature preprocessor retrieves passive DNS data from passive DNS records corresponding to known malicious or benign domain names collected across one or more organizations. The feature preprocessor generates feature vectors of the lightweight features for each collected passive DNS record. The lightweight features include a domain name, IP address octets, most frequent country codes, most frequent autonomous system numbers (ASNs), and historical passive DNS statistics. A classifier trainer trains a lightweight domain name classifier with the feature vectors and corresponding malicious or benign labels. Once trained, the classifier trainer tunes the classification threshold of the trained lightweight domain name classifier for a target percentage of malicious domain name detections based on available crawling resources. The trained lightweight domain name classifier is then deployed in an environment that handles a high volume of passive DNS records. In this environment, a traffic shaper shapes passive DNS records communicated to the trained lightweight domain name classifier, and any benign domain name classifications by the trained classifier are prefiltered (i.e., removed from the pipeline) prior to subsequent crawling operations. The use of lightweight features that are weak signals for malicious domain name detection allows for a classifier to act as an efficient prefilter prior to crawling, often reducing the number of domain names for crawling detection by an order of magnitude, thereby reducing network and computational resources while still crawling those domains most likely to be malicious.

### Example Illustrations

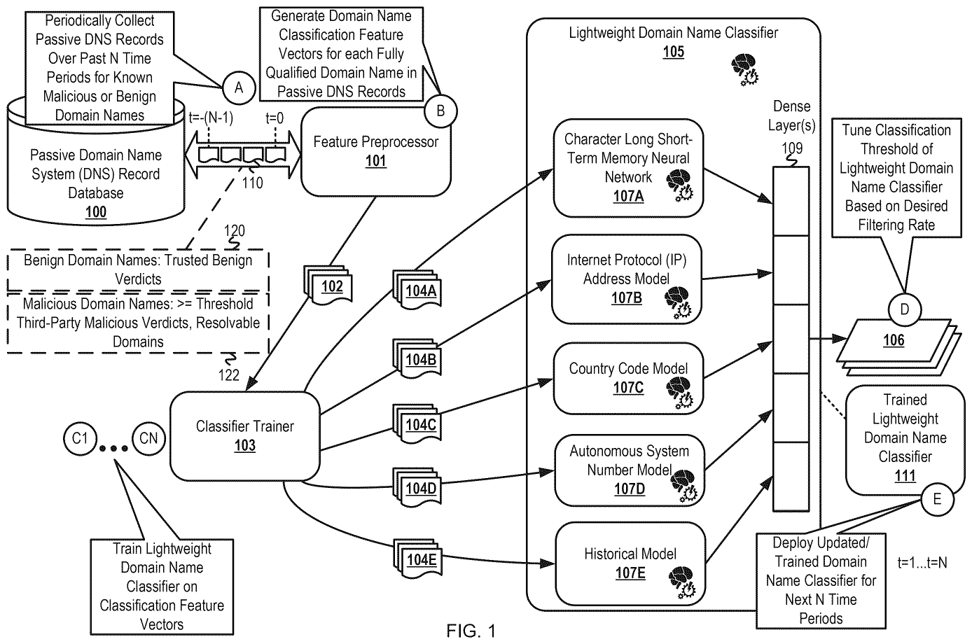

FIG. 1 is a schematic diagram of an example system for training a lightweight domain name classifier to prefilter domain names prior to crawling using weak signals for malicious domain name detection from passive DNS records. A feature preprocessor 101 retrieves passive DNS records for known malicious or benign domain names from a passive DNS record database 100 collected over the past N time periods t=−(N−1), . . . , t=0 and uses the passive DNS records to generate training feature vectors. A classifier trainer 103 trains a lightweight domain name classifier 105 on the training feature vectors and labels indicating whether corresponding domain names are known to be malicious or benign. Subsequent to training, the classifier trainer 103 tunes a classification threshold of the lightweight domain name classifier 105 to a desired percentage of malicious domain name classifications. The classifier trainer 103 then deploys a trained lightweight domain name classifier 111 for filtering of benign domain names in the subsequent N time periods t=1, . . . , t=N.

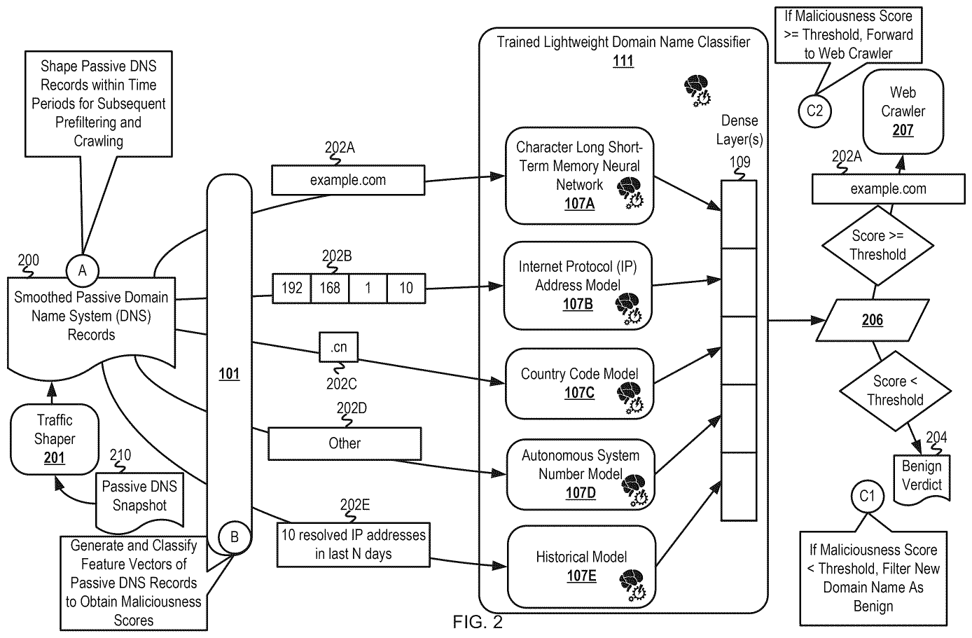

FIG. 1 is annotated with a series of letters/numbers A, B, C1-CN, D, and E and FIG. 2 is annotated with a series of letters/numbers A, B, C1, and C2 representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the feature preprocessor 101 retrieves passive DNS records 110 stored in the passive DNS record database 100 from the past N time periods (e.g., past 10 days) t=−(N−1), . . . , t=0. The passive DNS record database 100 can comprise a centralized storage across one or more organizations, and each time a DNS resolution is observed and recorded at a device associated with the one or more organizations, the device can communicate the passive DNS record of the DNS resolution to the passive DNS record database 100. The passive DNS database can periodically delete old passive DNS records (e.g., after every N time periods) due to the potentially high volume of passive DNS records.

The feature preprocessor 101 evaluates each domain name indicated in the passive DNS records 110 to determine whether a verdict for that domain name is benign, malicious, or unknown. As indicated in FIG. 1, a criterion 120 for a domain name to be benign is that the domain name is associated with a trusted benign verdict, e.g., a benign verdict from a cybersecurity service serving the one or more organizations. Additionally, a criterion 122 for a domain name to be malicious is that the domain name has greater than a threshold number of third-party malicious verdicts and that the domain name is resolvable (e.g., as indicated in corresponding passive DNS records). The feature preprocessor 101 filters passive DNS records that are unknown (i.e., that do not satisfy either of the above criteria) from the passive DNS records 110 prior to generating training data.

At stage B, the feature preprocessor 101 generates domain name classification feature vectors for each FQDN indicated in the passive DNS records 110. Features for the classification feature vectors include domain names, IP address octets, country codes, ASNs, and historical statistics. Each IP address octet corresponds to a different level of granularity for corresponding networks, organizations, devices, etc. and thus a different potential perspective for detecting maliciousness. When generating values of the country code and ASN features, the feature preprocessor 101 computes frequencies of all country codes and ASNs indicated in the passive DNS records 110 and replaces country codes and ASNs below a threshold frequency or cutoff number of country codes/ASNs (as ordered by frequency) with a placeholder “other” country code or ASN to capture the most frequent country codes/ASNs. For example, the feature preprocessor 101 may only keep values for the top-10 most frequent country codes and replace all other country codes with an “other” or placeholder value.

The historical statistics comprise a number of distinct IP addresses to which a hostname of an FQDN resolves, a frequency count of the FQDN, a first and last seen time of the hostname of the FQDN, and a number of time periods (e.g., number of days) that the hostname of the FQDN was seen in the past N time periods. This choice of historical statistics features is due to trusted FQDNs typically having more stable historical use with higher frequency and unique IP address resolutions, as well as typically being more established (i.e., using older registered hostnames). In the case where multiple passive DNS records in the passive DNS records 110 correspond to a same FQDN, the feature preprocessor 101 uses a first of the passive DNS records to compute the classification feature vector when generating values for the domain name, IP address octet, country code, and ASN features. The historical statistics for this first passive DNS record comprise statistics across the multiple passive DNS records of the same FQDN when computing values for the historical statistics features. The classification feature vectors generated by the feature preprocessor 101 include values 104A of the domain name feature, values 104B of the IP address octet feature, values 104C of the country code feature, values 104D of the ASN feature, and values 104E of the historical statistics features that are inputs to the lightweight domain name classifier 105 at a character long short-term memory (LSTM) neural network 107A, an IP address model 107B, a country code model 107C, an ASN model 107D, and a historical model 107E of the lightweight domain name classifier 105, respectively.

At stages C1-CN, the classifier trainer 103 trains the lightweight domain name classifier 105 on the feature values 104A-104E of the classification feature vectors until training termination criteria are satisfied. The training criteria can comprise that a threshold validation/training error is satisfied, that internal parameters of the lightweight domain name classifier 105 converge across iterations, that a threshold number of batches/epochs has occurred, etc. At each training iteration, the classifier trainer 103 inputs the feature values 104A-104E into respective ones of the models 107A-107E, and outputs of the models 107A-107E are fed into a dense layer(s) 109 that outputs malicious or benign verdicts (or scores that indicate those verdicts) 106. The malicious or benign verdicts 106 are then compared with malicious or benign labels of the corresponding domain names determined according to the foregoing criteria to compute loss, and the loss is backpropagated through the lightweight domain name classifier 105. Depending on architecture and implementation, loss can be backpropagated through both the dense layer(s) 109 and each or a subset of the models 107A-107E.

Each of the models 107B-107E comprises a neural network classifier, machine learning model, or other classifier (e.g., a support vector machine, random forest classifier, etc.) effective at classifying the respective input features and configured to receive the respective feature values as inputs. The character LSTM neural network 107A comprises an input layer that generates natural language processing (NLP) embeddings of domain names prior to the LSTM architecture. Although depicted as a character LSTM neural network, the character LSTM neural network 107A can alternatively comprise any classifier effective at classifying domain names (e.g., a convolutional neural network). The models 107A-107E are chosen to have a lightweight architecture (e.g., a few thousand internal parameters) to handle the high volume of passive DNS records (e.g., millions per hour) expected during deployment.

At stage D, the classifier trainer 103 tunes a classification threshold of the lightweight domain name classifier 105 according to a desired filtering rate. The desired filtering rate/percentage is based on operational constraints for a system that prefilters likely benign domain names using passive DNS records prior to crawling the domain names. For instance, the classifier trainer 103 may target a 10% malicious detection rate when tuning the classification threshold, thereby reducing the crawling resources required by potentially an order of magnitude. Although this tuning of the classification threshold may result in false negatives (i.e., false benign domain name classifications), these false negative domain names would not otherwise have been crawled due to the operational constraints, and the most likely malicious domain names detected by the lightweight domain name classifier 105 are still crawled for malicious website detection.

A stage E, the classifier trainer 103 deploys the trained lightweight domain name classifier 111 over the next N time periods t=1, . . . , t=N for prefiltering of domain names prior to crawling the domain names for malicious website detection. The trained lightweight domain name classifier 111 may replace a previously deployed classifier trained prior to the past N time periods t=−(N−1), . . . , t=0. Generation of feature vectors and training can occur in the cloud, and the trained lightweight domain name classifier 111 can then be downloaded to one or more prefiltering deployment instances. Periodic retraining of the trained lightweight domain name classifier 111 ensures that most recent malicious behaviors (e.g., zero-day malicious behaviors) are detected.

FIG. 2 is a schematic diagram of an example system for deploying a trained lightweight domain name classifier to prefilter domain names prior to crawling the domain names for malicious website detection. FIG. 2 depicts the trained lightweight domain name classifier 111 from FIG. 1 that has previously been trained on recent passive DNS records to prefilter likely benign domain names using features corresponding to at least partially weak signals from passive DNS records, as well as the feature preprocessor 101 that is configured to generate classification feature vectors from passive DNS records.

At stage A, a traffic shaper 201 receives a passive DNS snapshot 210 and shapes the passive DNS snapshot 210 to obtain smoothed passive DNS records 200. The passive DNS snapshot 210 comprises a database snapshot of passive DNS records collected in a previous time period, e.g., records collected in the past hour in the passive DNS record database 100 described above in reference to FIG. 1. As an example, the passive DNS snapshot 210 can comprise a BigQuery® table snapshot of a BigQuery database or data warehouse. The traffic shaper 201 shapes the passive DNS snapshot 101 according to operational constraints of the trained lightweight domain name classifier 111, e.g., by restricting or buffering traffic flow at a bandwidth such that the feature preprocessor 101 and the trained lightweight domain name classifier 111 are able to generate and classify feature vectors from the smoothed passive DNS records 200 at that bandwidth. The trained lightweight domain name classifier 111 may be deployed in multiple, parallel instances to help handle overall load.

At stage B, the feature preprocessor 101 generates features vectors from the smoothed passive DNS records 200 and the trained lightweight domain name classifier 111 classifies the feature vectors to obtain maliciousness scores. The remaining operations in FIG. 2 are depicted for a single feature vector for illustrative purposes. The feature preprocessor 101 maintains historical statistics for each FQDN when computing values of the historical statistics features and can update these historical statistics based on observed passive DNS records. In some embodiments, these historical statistics can alternatively be maintained/updated in a centralized passive DNS record database and the statistics can be indicated in passive DNS records communicated from the database to the traffic shaper 201 in each snapshot. In the example depicted in FIG. 1, a domain name feature value 202A is “example. com”, an IP octet feature value 202B comprises the octets “192”, “168”, “1”, and “10” corresponding to the IP address 198.162.1.10, a country code feature value 202C comprises “.cn”, an ASN feature value comprises “other” (i.e., the ASN was not frequent enough to be included as a feature value), and a historical statistics feature value 202E comprises “10 resolved IP addresses in last N days”. The text representation of the feature value 202E is for illustrative purposes and the numerical representation “10” of the feature value 202E would instead be input to the trained lightweight domain name classifier 111 in practice.

Stages C1 and C2 depict operations that occur if a maliciousness score 206 output by the trained lightweight domain name classifier 111 is below or above a classification threshold (i.e., the classification threshold tuned at stage D as described above in reference to FIG. 1), respectively. At stage C1, if the maliciousness score 206 is less than the classification threshold, the corresponding domain name receives a benign verdict 204 and the domain name is filtered from any subsequent crawling operations. In some embodiments, the domain name may not receive any verdict due to possible low confidence of verdicts output by the trained lightweight domain name classifier 111.

At stage C2, if the maliciousness score 206 is greater than or equal to the threshold, the trained lightweight domain name classifier 111 communicates the domain name feature value 202A to a web crawler 207. The web crawler 207 subsequently crawls the domain name to obtain a HyperText Transfer Protocol (HTTP) response(s) from which stronger signals for malicious website detection can be obtained. Signals from the HTTP response(s) are used in additional classifiers to determine with greater confidence whether the domain name is malicious and whether to perform any remediation action(s) thereof.

FIG. 2 describes feature vectors for passive DNS records being generated using per-FQDN historical statistics, whereas subsequent verdicts output by the trained lightweight domain name classifier 111 are applied to domain names rather than FQDNs. This can vary by implementation and, alternatively, verdicts can be applied per-FQDN instead of per-domain name. Subsequent to flagging or communicating domain names for crawling, additional operations can be performed such as deduplicating domain names that were flagged multiple times and removing domain names that have been recently crawled. In some embodiments, when there are multiple passive DNS records in the smoothed passive DNS records 200 corresponding to a same FQDN or domain name, the verdict for that FQDN or domain name can be determined based on a maximal maliciousness score or a majority vote of verdicts across the multiple records.

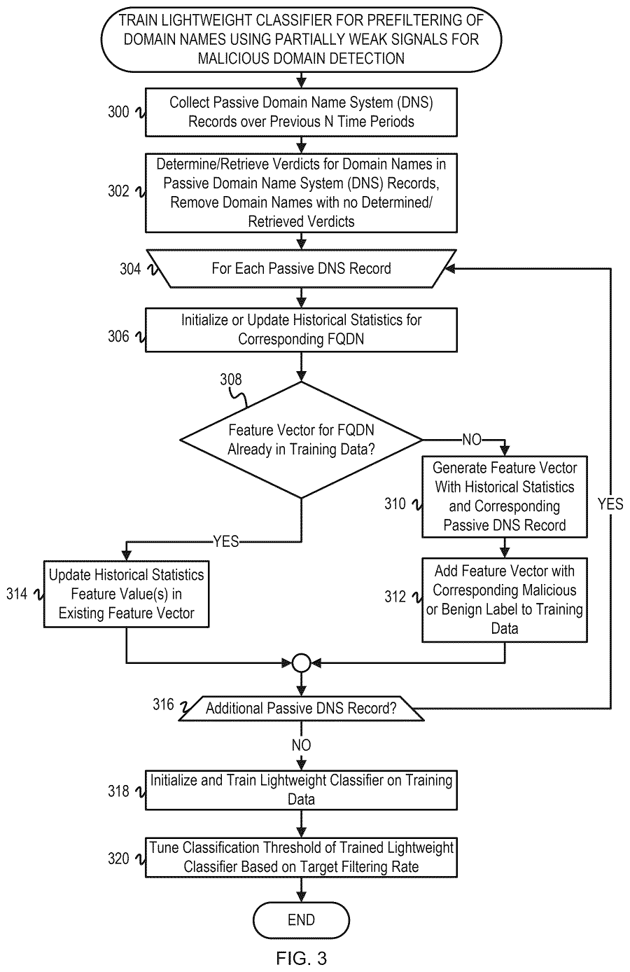

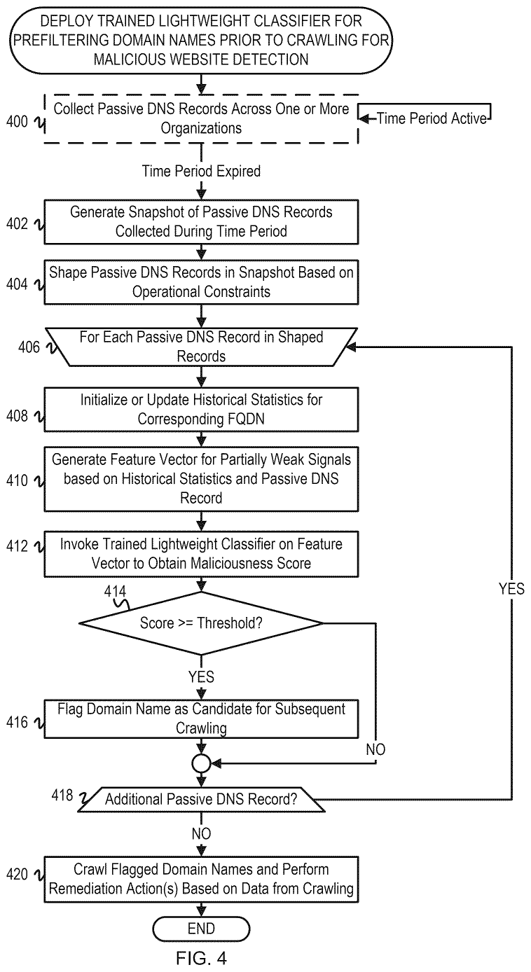

FIGS. 3-4 are flowcharts of example operations for training and deploying lightweight classifiers for prefiltering likely benign domain names prior to crawling the domain names for malicious website detection. The example operations are described with reference to a passive DNS record database, a feature preprocessor, a classifier trainer, a lightweight domain name classifier, and a traffic smoother for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for training a lightweight classifier for prefiltering of domain names using partially weak signals for malicious domain detection. At block 300, a passive DNS record database collects passive DNS records over a previous N time periods (e.g., 7 days). The previous N time periods comprise time periods for which a most recently trained lightweight classifier is expected to maintain performance, and can be shortened or lengthened depending on available computing resources for training lightweight classifiers. The passive DNS records are collected by observing and recording DNS resolutions at devices across one or more organizations, wherein the devices are configured to communicate all passive DNS records to the passive DNS record database.

At block 302, the feature preprocessor determines and/or retrieves verdicts for domain names in the passive DNS records and removes domain names with no determined or retrieved verdicts. For instance, the feature preprocessor can enumerate each unique domain name in the collected passive DNS records and can query one or more third-party services with the unique domain names to retrieve malicious or benign verdicts. Malicious or benign verdicts can be augmented using verdicts from cybersecurity services maintaining security for the one or more organizations. The malicious or benign verdicts can be determined using respective criteria, e.g., a benign verdict can be determined if there is a trusted benign verdict such as a benign verdict by a cybersecurity service of the one or more organizations, and a malicious verdict can be determined if there is more than a threshold number of malicious verdicts from the third-party services and the domain is resolvable. The feature preprocessor removes domain names satisfying neither of the criteria (i.e., that could not be identified as malicious or benign). As an additional step prior to determining/retrieving verdicts, the feature preprocessor can remove passive DNS records that do not include adequate information for generating feature vectors, for instance passive DNS records that do not include IP addresses.

At block 304, the feature preprocessor begins iterating through passive DNS records. The feature preprocessor can iterate through passive DNS records in the order that they were collected by the passive DNS record database, for instance by increasing order of timestamps.

At block 306, the feature preprocessor initializes or updates historical statistics for an FQDN corresponding to the current passive DNS record. The historical statistics can include a number of distinct IP addresses that the hostname resolves to within the past N time periods, a number of passive DNS records where the was FQDN in the past N time periods, the first and last timestamps for passive DNS records where the FQDN was indicated, and the number of time periods in the past N time periods where a passive DNS record including the FQDN was observed. Assuming that the current passive DNS record included a distinct IP address, then updating the historical statistics in this example comprises incrementing the number of distinct IP addresses, incrementing the number of passive DNS records, updating the last timestamp with the timestamp indicated in the current passive DNS record, and incrementing the number of time periods (assuming a passive DNS record indicating the FQDN has not previously been observed in the current time period).

At block 308, the feature preprocessor determines whether a feature vector for the FQDN is already in the training data. The example operations in FIG. 3 assume that a single representative feature vector is being generated for each FQDN, and that the representative feature vector corresponds to the first passive DNS record where that FQDN was observed. In other embodiments when there are multiple passive DNS records for a single FQDN, a separate feature vector can be generated for each passive DNS record (omitting the check at block 308), or an arbitrary or random one of the passive DNS records can be chosen for generating the feature vector. If the feature preprocessor determines that a feature vector for the FQDN is already in the training data, operational flow proceeds to block 314. Otherwise, operational flow proceeds to block 310.

At block 310, the feature preprocessor generates a feature vector with the historical statistics and the corresponding passive DNS record. Features used to generate the feature vector as described in the foregoing include the domain name, IP address octets, frequency-based country code and ASN features, and historical statistics features. These features correspond to (typically) partially weak signals for malicious website detection but are advantageous due to being efficiently computable and using data from passive DNS records. Any additional or alternative features that use data from passive DNS records and are efficient to compute are additionally anticipated by the present disclosure.

At block 312, the feature preprocessor adds the feature vector with the corresponding malicious or benign label to the training data. Operational flow continues from block 312 to block 316.

At block 314, the feature preprocessor updates a historical statistics feature value(s) in the existing feature vector for the FQDN. The feature preprocessor updates the historical statistics feature value(s) based on the updated historical statistics from block 306.

At block 316, the feature preprocessor continues iterating through passive DNS records. If there is an additional passive DNS record, operational flow returns to block 304. Otherwise, operational flow proceeds to block 318.

At block 318, the feature preprocessor initializes a lightweight classifier and trains the lightweight classifier on the training data. The lightweight classifier comprises models that take distinct sets of feature values as inputs—a model that takes the domain name as input, a model that take the IP address octets as inputs, a model that takes the frequency-based country code as input, a model that takes the frequency-based ASN as input, and a model that takes the historical statistics as input. Each of the models can itself comprise a classifier/machine learning model (e.g., a neural network classifier, a support vector machine, etc.), and outputs of these models are input to one or more dense layers that output a maliciousness score. Training occurs until training termination criteria occur, e.g., that a threshold number of iterations have occurred, that training/validation error are low, etc. Depending on implementation, each of the sub-models that takes a set of feature values as input can be trained separately and then have fixed internal parameters during training of the lightweight classifier, or alternatively the lightweight classifier can be trained as an ensemble with loss backpropagated through the dense layers and each of the models (or a subset of the models).

At block 320, the feature preprocessor tunes a classification threshold of the trained lightweight classifier based on a target filtering rate. The target filtering rate depends on available computing resources for a deployment environment of the trained lightweight classifier and the volume of passive DNS records to be classified. As an example, if the target filtering rate is to filter all but 10% of domain names that are detected as malicious and the current detection rate is 50%, the classification threshold is successively increased until only 10% of the training data is classified as malicious.

FIG. 4 is a flowchart of example operations for deploying a trained lightweight classifier for prefiltering domain names prior to crawling for malicious website detection. The operations in FIG. 4 assume that a lightweight classifier has previously been trained using partially weak signals from passive DNS records to be a prefilter of likely benign domain names prior to crawling the domain names. Many of the operations in FIG. 4 are described in brevity due to overlap with operations described in reference to FIG. 3.

At block 400, the passive DNS record database collects passive DNS records across one or more organizations. Block 400 is depicted with a dashed outline to indicate that collection of passive DNS records occurs independently of the remaining operations in FIG. 4. The remaining operations in FIG. 4 are triggered upon expiration of a refreshing time period (e.g., every hour).

At block 402, the passive DNS record database generates a snapshot of the passive DNS records collected during the expired time period. For instance, the passive DNS record database can generate a BigQuery table snapshot of the passive DNS records collected during the previous time period.

At block 404, the traffic shaper shapes the passive DNS records in the snapshot based on operational constraints. The operational constraints can specify a bandwidth of passive DNS records that the trained lightweight classifier is able to handle and can buffer the passive DNS records and release them to the feature preprocessor according to the bandwidth.

At block 406, the feature preprocessor receives the current passive DNS record as it is communicated by the traffic shaper. At block 408, the feature preprocessor initializes or updates historical statistics for an FQDN corresponding to the current passive DNS record. At block 410, the feature preprocessor generates a feature vector for partially weak signals based on the historical statistics and the current passive DNS record. When determining frequency of country codes and ASNs for computing the country code and ASN feature values, the feature preprocessor can maintain frequency counters of each country code and ASN within a sliding time window prior to the current passive DNS record (e.g., past 7 days). The feature preprocessor can maintain timestamps associated with occurrences of each country code/ASN, so that the frequency can be decremented when these timestamps are no longer within the sliding time window.

At block 412, the feature preprocessor invokes the trained lightweight classifier on the feature vector to obtain a maliciousness score. At block 414, if the maliciousness score is greater than or equal to a classification threshold (e.g., a classification threshold tuned for a target filtering rate), then operational flow proceeds at block 416. Otherwise, operational flow skips to block 418.

At block 416, the feature preprocessor flags/designates the domain name as a candidate for subsequent crawling. In some embodiments, the feature preprocessor can deduplicate the flagged domain name if it has been flagged for crawling at a previous iteration for a previous passive DNS record. Although the flagged domain names have been identified as malicious by the trained lightweight classifier, because this identification is based on partially weak signals, subsequent crawling and additional classification is performed to increase confidence of the malicious verdict.

At block 418, the feature preprocessor continues receiving passive DNS records shaped by the traffic shaper according to the bandwidth. If there is an additional passive DNS record in the snapshot shaped by the traffic shaper, operational flow returns to block 406. Otherwise, operational flow proceeds to block 420.

At block 420, a web crawler crawls the flagged domain names for HTTP responses and classifies data in the HTTP responses to obtain higher confidence malicious or benign verdicts for the flagged domain names. The web crawler (or other cybersecurity component) then performs remediation actions based on any higher confidence malicious verdicts, such as by blocking network traffic to the corresponding domain names.

### Variations

The foregoing description refers to generating verdicts per-domain name and generating feature vectors having per-FQDN historical statistics. These constraints can vary by implementation. For instance, both verdicts and historical statistics can be per-FQDN or per-domain name. Moreover, when generating a verdict for a domain name or FQDN corresponding to multiple feature vectors, the verdict can comprise a verdict for the earliest occurring feature vector, a majority verdict across feature vectors, a verdict for the maximal maliciousness score among feature vectors, a verdict for an arbitrarily or randomly chosen feature vector, etc.

The foregoing description refers to collecting training data for training lightweight domain name classifiers in the past N time periods for subsequent deployment in the next N time periods. In some embodiments, collection of training data and training can occur in a sliding time window of the past N time periods, and as data is collected from newer time periods, data older than the past N time periods can be deleted/removed from training data. This allows for flexibility for configuring precisely when a classifier can be retrained.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 408, 410, 412, 414, and 416 can be performed in parallel across passive DNS records. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

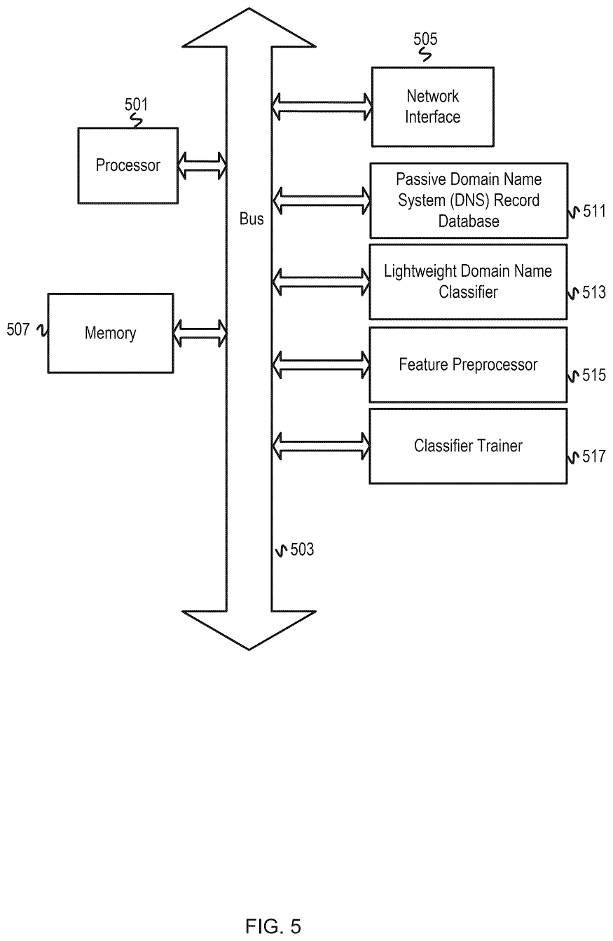

FIG. 5 depicts an example computer system with a passive DNS record database, a lightweight domain name classifier, a feature preprocessor, and a classifier trainer. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a passive DNS record database 511, a lightweight domain name classifier 513, a feature preprocessor 515, and a classifier trainer 517. According to a training schedule (e.g., every week), the passive DNS record database 511 collects passive DNS records and the feature preprocessor 515 retrieves malicious or benign labels for at least a subset of domain names indicated in the passive DNS records. The feature preprocessor 515 then generates feature vectors from the passive DNS records corresponding to features that are at least partially weak signals for malicious domain name detection. The classifier trainer 517 trains the lightweight domain name classifier 513 to prefilter domain names prior to crawling the domain names for malicious detection using the feature vectors and corresponding malicious or benign labels. Once trained, the lightweight domain name classifier 513 is deployed in a high load environment for prefiltering domain names corresponding to passive DNS records classified as benign prior to crawling those domain names. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
identifying candidate domain names from a plurality of domain names for malicious domain name detection using at least partially weak signals for malicious domain name detection in passive Domain Name System (DNS) records, wherein identifying the candidate domain names comprises, for each domain name of the plurality of domain names,
generating a plurality of passive DNS feature values for the domain name, wherein features for the plurality of passive DNS feature values comprise at least one of a domain name feature, Internet Protocol (IP) address features, a country code feature, an autonomous system number feature, and one or more historical statistics features;
invoking a machine learning model on the plurality of passive DNS feature values to obtain a verdict indicating whether the domain name is a candidate for crawling; and
based on obtaining a candidate verdict for the domain name, designating the domain name for crawling.

2. The method of claim 1, further comprising:
collecting training data in a sliding window; and
periodically retraining the machine learning model on the collected training data from the sliding window.

3. The method of claim 2, wherein malicious samples in training data for the machine learning model comprise samples with high confidence malicious verdicts.

4. The method of claim 1, further comprising generating one or more values for the domain name feature with a character long short-term memory neural network, wherein retraining the machine learning model comprises retraining the machine learning model as an ensemble with the character long short-term memory neural network.

5. The method of claim 1, wherein the one or more historical statistics features comprise at least one of a number of distinct IP addresses for DNS resolution of a hostname for the domain name in a most recent time window, a first time and a last time that the hostname was detected, a frequency count of occurrences of the hostname in the most recent time window, and a number of days that the hostname was detected in the most recent time window.

6. The method of claim 1, further comprising generating values for the country code feature and the autonomous system number feature, wherein generating values for the country code feature and the autonomous system number feature comprises:
determining frequency of country codes and autonomous system numbers in a most recent time period; and
based on determining that at least one of a country code and an autonomous system number for the domain name is below a threshold frequency in the most recent time period, replacing the at least one of the country code and the autonomous system number with at least one of a placeholder country code and a placeholder autonomous system number.

7. The method of claim 1, further comprising tuning a classification threshold value for the machine learning model for identifying a target percentage of domain names as candidate domain names.

8. A non-transitory machine-readable medium having program code stored thereon, the program code comprising instructions to:
based on receiving a passive Domain Name System (DNS) record corresponding to a domain name, generate a feature vector for the passive DNS record corresponding to features that are at least partially weak signals for malicious domain name detection, wherein the features comprise at least one of a domain name feature, Internet Protocol features, a country code feature, an autonomous system number feature, and one or more historical statistics features;
invoking a machine learning model on the feature vector to obtain a verdict indicating that the domain name is malicious or benign; and
based on the verdict indicating that the domain name is malicious, flagging the domain name for subsequent crawling.

9. The non-transitory machine-readable media of claim 8, wherein the program code further comprises instructions to, based on the verdict indicating that the domain name is benign, filter the domain name from crawling.

10. The non-transitory machine-readable media of claim 8, wherein the program code further comprises instructions to:
collect training data in a sliding window; and
periodically retrain the machine learning model on the collected training data from the sliding window.

11. The non-transitory machine-readable media of claim 8, wherein the one or more historical statistics features comprise at least one of a number of distinct IP addresses for DNS resolution of a hostname for the domain name in a most recent time window, a first time and a last time that the hostname was detected, a frequency count of occurrences of the hostname in the most recent time window, and a number of days that the hostname was detected in the most recent time window.

12. The non-transitory machine-readable media of claim 8, wherein the program code further comprises instructions to generate values for the country code feature and the autonomous system number feature, wherein the instructions to generate values for the country code feature and the autonomous system number feature comprise instructions to:
determine frequency of country codes and autonomous system numbers in a most recent time period; and
based on determining that at least one of a country code and an autonomous system number for the domain name is below a threshold frequency in the most recent time period, replace the at least one of the country code and the autonomous system number with at least one of a placeholder country code and a placeholder autonomous system number.

13. The non-transitory machine-readable media of claim 8, wherein the program code further comprises instructions to tune a classification threshold value for the machine learning model for flagging a target percentage of domain names as candidate domain names.

14. An apparatus comprising:
a processor; and
a machine-readable medium having instructions stored thereon that are executable by the processor to cause the apparatus to,
filter domain names indicated in passive Domain Name System (DNS) records from being crawled for malicious detection, wherein the instructions to filter domain names indicated in passive DNS records comprise instructions executable by the processor to cause the apparatus to, for each received passive DNS record indicating a domain name,
generate a feature vector for the passive DNS record corresponding to features that are at least partially weak signals for malicious domain name detection, wherein the features comprise at least one of a domain name feature, Internet Protocol features, a country code feature, an autonomous system number feature, and one or more historical statistics features;
invoke a machine learning model on the feature vector to obtain a verdict indicating that the domain name is malicious or benign; and
based on the verdict indicating that the domain name is benign, filter the domain name from being crawled.

15. The apparatus of claim 14, wherein the machine-readable medium further has stored thereon instructions executable by the processor to cause the apparatus to, based on the verdict indicating that the domain name is malicious, indicate the domain name for subsequent crawling.

16. The apparatus of claim 14, wherein the machine-readable medium further has stored thereon instructions executable by the processor to cause the apparatus to:
collect training data in a sliding window; and
periodically retrain the machine learning model on the collected training data from the sliding window.

17. The apparatus of claim 14, wherein the one or more historical statistics features comprise at least one of a number of distinct IP addresses for DNS resolution of a hostname for the domain name in a most recent time window, a first time and a last time that the hostname was detected, a frequency count of occurrences of the hostname in the most recent time window, and a number of days that the hostname was detected in the most recent time window.

18. The apparatus of claim 14, wherein the machine-readable medium further has stored thereon instructions executable by the processor to cause the apparatus to generate values for the country code feature and the autonomous system number feature, wherein the instructions to generate values for the country code feature and the autonomous system number feature comprise instructions executable by the processor to cause the apparatus to:
determine frequency of country codes and autonomous system numbers in a most recent time period; and
based on determining that at least one of a country code and an autonomous system number for the domain name is below a threshold frequency in the most recent time period, replace the at least one of the country code and the autonomous system number with at least one of a placeholder country code and a placeholder autonomous system number.

19. The apparatus of claim 14, wherein the machine-readable medium further has stored thereon instructions executable by the processor to cause the apparatus to tune a classification threshold value for the machine learning model for filtering a target percentage of domain names from being crawled.

20. The apparatus of claim 14, wherein the machine-readable medium further has stored thereon instructions executable by the processor to cause the apparatus to maintain values of the one or more historical statistics features for each domain name indicated in passive DNS records.
